(19) United States
(12) Patent Application Publication
(10) Pub. No.: US 2012/0137591 A1
(43) Pub. Date: Jun. 7, 2012

(54) Driving Device

(75) Inventors: Marian BOCHEN, Eitelborn (DE); Dave Sabet, Beverly Hills, CA (US)

(73) Assignee: Stabilus GmbH, Koblenz (DE)

(21) Appl. No.: 13/155,444

(22) Filed: Jun. 8, 2011

(30) Foreign Application Priority Data
Dec. 3, 2010 (DE) 10 2010 053 225.8

(51) Int. Cl. F16H 25/12; E05F 15/10; B60J 5/00

(52) U.S. Cl. 49/324; 74/89.23

(57) ABSTRACT

A driving device has a housing tube that can be connected to a stationary base part, particularly to a vehicle body, or to a movable structural component part, particularly a vehicle hatch or vehicle door, a protective tube connected to the other respective part, a spindle drive that has a threaded spindle and a spindle nut arranged on the threaded spindle by which the housing tube and protective tube are movable axially relative to one another, and a rotary drive that drives the spindle drive in rotation and includes at least one electric motor. A sensor device conveys the current position in relation to the earth's magnetic field or plumb line and one or more corresponding signals to a control device is arranged in the driving device.

### BACKGROUND OF THE INVENTION

1. Field of the Invention

The invention is directed to a driving device, particularly for a hatch in a vehicle, having a housing tube that can be connected to a stationary base part, particularly to a vehicle body, or to a movable structural component part, particularly a vehicle hatch or vehicle door, a protective tube that can be connected to the other of the movable structural component part or the stationary base part, a spindle drive having a threaded spindle and a spindle nut arranged on the threaded spindle by which the housing tube and protective tube are movable axially relative to one another, and a rotary drive that drives the spindle drive in rotation and which comprises at least one electric motor.

2. Description of the Related Art

There are many known variations of driving devices of the type mentioned above. However, it is a disadvantage in these drives that an erroneous calculation of the hatch position can occur during manual operation while the connected control device is inactive or when the coupling installed in the spindle drive is disengaged. Therefore, it is no longer possible for the rear hatch to move reliably to the end positions, i.e., the completely opened position or completely closed position.

### SUMMARY OF THE INVENTION

It is an object of one embodiment of the invention to provide a driving device of the type mentioned above having a simple and inexpensive construction in which an accurate calculation of the hatch position is possible.

According to one embodiment of the invention, a sensor device that conveys the current hatch position in relation to the earth's magnetic field or a plumb line and corresponding signals to a control device is arranged in the driving device. In order to economize on installation space in the driving device and to simplify assembly, a safety circuit is arranged on an electronics circuit board in the housing tube.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Embodiment examples of the invention are shown in the drawings and described more fully in the following in the drawings:

FIG. 1 is a schematic view of a motor vehicle with swivelably driven rear hatch; and

FIG. 2 is a cross section through a driving device.

### DETAILED DESCRIPTION OF THE PRESENTLY PREFERRED EMBODIMENTS

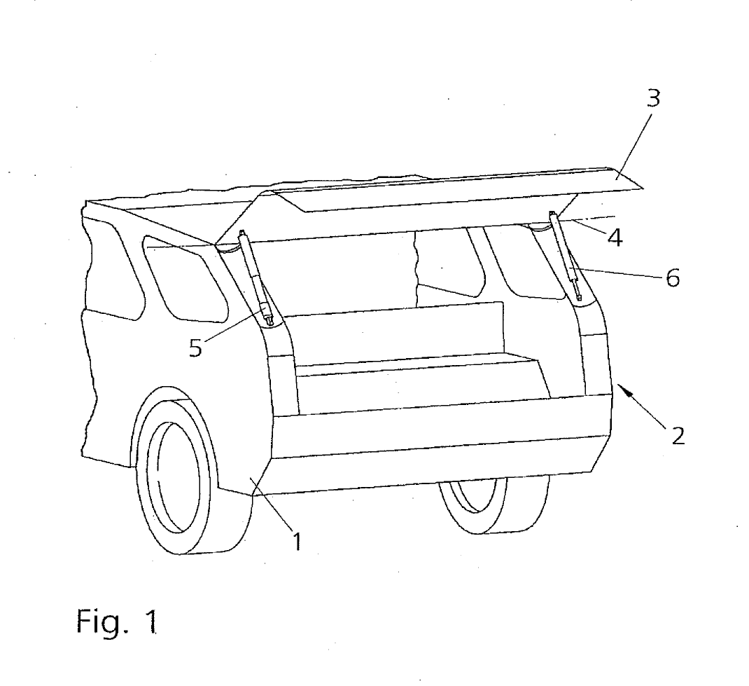

FIG. 1 shows a schematic diagram of a motor vehicle with a body as base part 1 and a movable structural component part 3 embodied as a hatch that closes or opens an opening 2 in the base part 1 and is constructed as a rear hatch.

The structural component part 3 that is movable relative to the base part 1 can also be a front hood or engine hood, a vehicle door, or a corresponding application.

In one embodiment, the movable structural component part 3 is mounted at a horizontal swiveling axis 4 extending transverse to the vehicle. A first driving device 5 is arranged at one side of the movable structural component part 3. A second driving device 6 is arranged at the opposite side of the hatch 3.

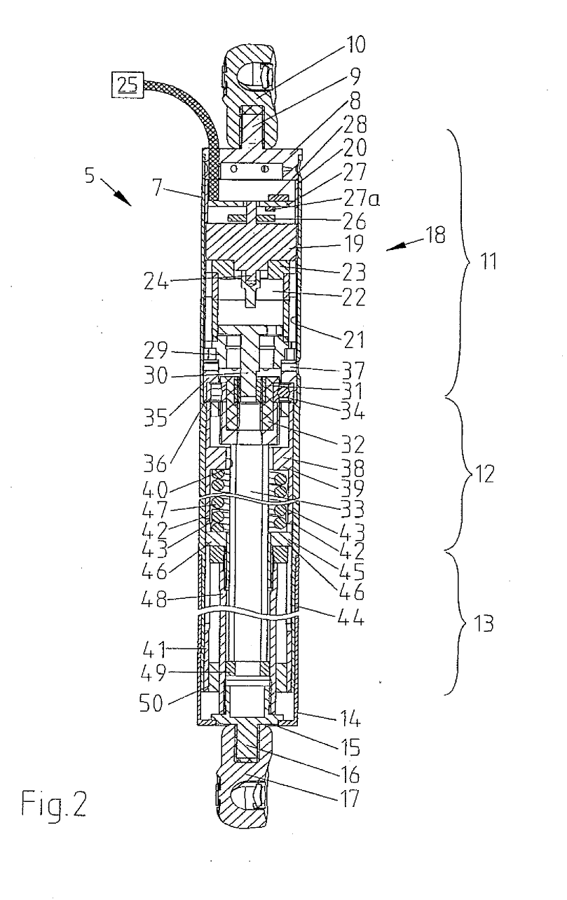

By way of example, FIG. 2 is an embodiment of one of the two driving devices 5, 6 in the form of an electromechanical driving device which will be associated with the first driving device 5 in the following description for the sake of simplicity. The second driving device 6 can also be an electromechanical driving device or, as is shown in FIG. 1, a gas spring.

The first driving device 5 has a housing tube 7 that is closed at one end by a base piece 8. The base piece 8 has a threaded pin 9 on which a connection element 10 is screwed.

The housing tube 7 has a first portion 11, a second portion 12, and a third portion 13. The first portion 11 has a larger inner diameter than the second portion 12 while its outer diameter remains the same. In contrast, the third portion 13 has a smaller outer diameter than the second portion 12 but the same inner diameter as second portion 12.

A protective tube 14 whose outer diameter substantially corresponds to the outer diameter of the second portion 12 of the housing tube 7 is arranged over the third portion 13 of the housing tube 7. The protective tube 14 is closed by a base piece 15 at its end remote of the housing tube 7. The base piece 15 has a threaded pin 16 on which a connection element 17 is screwed. By connection elements 10 and 17, the first driving device 5 can be connected in an articulated manner to a stationary body part or base part 1 of a motor vehicle and at a movable structural component part 3 of the motor vehicle that in one embodiment is formed as a hatch.

A rotary drive 18 is arranged in the interior of the housing tube 7 in the area of the first portion 11. The rotary drive 18 comprises an electric motor 19, a sensor device accommodated in a sensor housing 20, and a gear unit 22 accommodated in a gear unit housing 21. The electric motor 19 is supported by the sensor housing 20 at the end of the housing tube 7 that is closed by the base piece 8. The gear unit housing 21 is supported at the electric motor 19 by an adapter sleeve 23. The gear unit 22 arranged in the gear unit housing 21 is driven by a motor driveshaft 24. Further, the motor driveshaft 24 projects into the sensor housing 20 on the side located opposite to the gear unit housing 21. The connection lines comprising the power supply lines and control lines extend from the sensor housing 20 through the base piece 8 and out of the housing tube 7. The electric motor 19 can be connected to an energy source in particular an automobile battery, or to a control device 25 by these connection lines.

The motor driveshaft 24 projecting into the sensor housing 20 carries a permanent magnet 26 located axially opposite an electronics circuit board 27 arranged in a stationary manner near the free end of the motor driveshaft 24 at the sensor housing 20 or, alternatively, at the housing tube 7. On the side facing the permanent magnet 26, the electronics circuit board 27 has at least one Hall element 27a of an arrangement for sensing speed and rotating direction. A sensor 28 preferably always senses the current position in relation to the earth's magnetic field or plumb line and conveys corresponding signals to the control device 25 and is arranged on the side of the electronics circuit board 27 remote of the permanent magnet 26.

The gear unit housing 21 is closed at the side located opposite to the electric motor 19 by a housing cover 29 through which a transmission shaft 30 extends. The end of the transmission shaft 30 is connected to a spindle drive. For this purpose, an adapter insert 31 is located at the end of the transmission shaft 30, a spindle adapter 32 being arranged at the adapter insert 31. A threaded spindle 33 is connected to the transmission shaft 30 by the adapter insert 31 and spindle adapter 32.

The spindle adapter 32 is supported in a bearing 34. The bearing 34 is in turn arranged in a bearing sleeve 35 supported at the gear unit housing 21 or housing cover 29 on one side and at a step 36 on the other side, this step 36 being formed by the different inner diameters of portions 11 and 12. Accordingly, the rotary drive 18, together with the bearing 34 of the threaded spindle 33, is fixed in axial direction inside the first portion 11 of the housing tube 7. Parts of the rotary drive 18 can be connected to the housing tube 7 by screws 37 or dimples in such a way that these parts cannot rotate relative to the housing tube 7.

A spring sleeve 38 is supported at the bearing 34 or at the bearing sleeve 35, substantially in the second portion 12, so as to contact the inner wall of the housing tube 7. A wall 39 with a bore hole 40 is formed in the interior of the spring sleeve 38, the threaded spindle 33 projecting through this bore hole 40. The spring sleeve 38 is lengthened by a guide tube 41 starting from the second portion 12 of the housing tube 7 in direction of the third portion 13 to the end of the housing tube 7. The spring sleeve 38 has recesses 42 at its end near the guide tube 41. Projections 43 formed at the end of the guide tube 41 near the spring sleeve 38 engage in recesses 42 so that the spring sleeve 38 and guide tube 41 are prevented from rotating relative to one another. Further, the guide tube 41 has at least one guide device 44 that extends in axial direction and is formed as a slot. A projection 46 formed at a spindle nut 45 projects into this guide device 44.

A spring element 47 partially encloses the threaded spindle 33 and extends from the side of the wall 39 remote of the bearing 34 in direction of the third portion 13 of the housing tube 7 and comes into contact with the spindle nut 45 running on the threaded spindle 33, in particular when the first driving device 5 is inserted, i.e., the hatch 3 is positioned so as to be almost completely closed. The spring element 47 tends to force the spindle nut 45 away from the wall 39 when opening the hatch 3 from its completely closed position and accordingly reinforces the rotary drive 18 at least along the initial centimeters of the hatch opening movement.

A spindle tube 48 is guided in the guide tube 41 so as to be axially movable by the spindle nut 45, the spindle tube 48 being arranged with one end supported at the spindle nut 45 and with its other end at the base piece 15 of the protective tube 14. At the end near the base piece 15, the threaded spindle 33 has a guide ring 49 arranged in the spindle tube 48 so that the threaded spindle 33 is prevented from swinging radially.

Another guide ring 50 which likewise prevents a radial swinging of the telescopically extensible structural component parts and forms a stable protection against bending is arranged between the spindle tube 48 and the end of the housing tube 7 near the connection element 17.

The vehicle position with respect to pitch or inclination can be determined without requiring a second sensor in the vehicle body by arranging the tilt sensor 28 in the interior of the driving device 5 and by permanently zeroing the sensor signal when the hatch is locked, i.e., in its completely closed position.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A driving device comprising:
a housing tube connectable to one of a stationary base part and a movable structural component part;
a protective tube connectable to the other of the movable structural component part and the stationary base part;
a spindle drive having a threaded spindle and a spindle nut arranged on the threaded spindle by which the housing tube and protective tube are movable axially relative to one another;
a rotary drive configured to drive the spindle drive in rotation that comprises at least one electric motor; and
a sensor device arranged in the driving device configured to convey a current position in relation to one of Earth's magnetic field and a plumb line and one or more corresponding signals to a control device.

2. The driving device according to claim 1, further comprising a safety circuit arranged on an electronics circuit board in the housing tube.

3. The driving device according to claim 1, wherein the stationary base part is a vehicle body.

4. The driving device according to claim 1, wherein the movable structural component part is one of a vehicle hatch and a vehicle door.
